(19) United States
(12) Patent Application Publication
(10) Pub. No.: US 2024/0126950 A1
(43) Pub. Date: Apr. 18, 2024

(54) THERMAL ANALYSIS METHOD, THERMAL ANALYSIS APPARATUS, AND COMPUTER PROGRAM

(71) Applicant: Murata Manufacturing Co., Ltd., Kyoto-fu (JP)

(72) Inventors: Yuu YAMAYOSE, Nagaokakyo-shi (JP); Teruhisa SHIBAHARA, Nagaokakyo-shi (JP); Masataka FUKUNISHI, Nagaokakyo-shi (JP)

(73) Assignee: Murata Manufacturing Co., Ltd., Kyoto-fu (JP)

(21) Appl. No.: 18/391,784

(22) Filed: Dec. 21, 2023

Related U.S. Application Data
(63) Continuation of application No. PCT/JP2022/023044, filed on Jun. 8, 2022.

(30) Foreign Application Priority Data
Jul. 8, 2021 (JP) 2021-113879

(51) Int. Cl. G06F 30/23

(52) U.S. Cl. CPC G06F 30/23; G06F 2119/08

(57) ABSTRACT

A thermal analysis method and apparatus, and a computer program that enable highly accurate heat transfer simulation of a structure or space, while reducing calculation costs. By performing thermal analysis on a structure or space using the calculation meshes generated by initial dividing means, the spatial distribution of heat flux vectors J and temperature gradient vectors ∇T are calculated; by calculating the volume integrals of the inner products J·∇T of the heat flux vectors J and the temperature gradient vectors ∇T for individual partitioned regions and acquiring the absolute values of the volume integrals, thermal management sensitivity indices are calculated for the partitioned regions. Subsequently, partition of calculation meshes and subdivision of partitioned regions are performed on a predetermined number of partitioned regions that indicate greater indices among the calculated thermal management sensitivity indices, for example one partitioned region. Thermal analysis is performed again using the calculation meshes.

### CROSS-REFERENCE TO RELATED APPLICATIONS

This application claims benefit of priority to International Patent Application No. PCT/JP2022/023044, filed Jun. 8, 2022, and to Japanese Patent Application No. 2021-113879, filed Jul. 8, 2021, the entire contents of each are incorporated herein by reference.

### BACKGROUND

### Technical Field

The present disclosure relates to a thermal analysis method for performing thermal analysis on a structure or space, a thermal analysis apparatus, and a computer program.

### Background Art

A known example of this kind of thermal analysis method, thermal analysis apparatus, and computer program is the automatic mesh generating apparatus, automatic mesh generating method, and program disclosed in Japanese Unexamined Patent Application Publication No. 2005-50137. This automatic mesh generating apparatus divides wiring patterns of three-dimensional structure model data into fine areas using a mesh generating unit. The automatic mesh generating apparatus subsequently acquires the physical property values of the fine areas using a physical property value acquiring unit. The automatic mesh generating apparatus, using a mesh reducing unit, refers to the physical property values of multiple adjacent fine areas, and when the physical property values of multiple adjacent fine areas are equal to each other, reduces the number of calculation meshes by treating the multiple fine areas as a single fine area.

Another known example of this kind of thermal analysis method, thermal analysis apparatus, and computer program is the thermal analysis method, thermal analysis apparatus, and thermal analysis program disclosed in Japanese Unexamined Patent Application Publication No. 2008-275579. In this thermal analysis method, modeling is carried out while terminals coupled to the ground pattern are treated separately from terminals not coupled to the ground pattern; and using the size of the connection area of the terminals coupled to the ground pattern and the substrate and the size of the connection area of the terminals not coupled to the ground pattern and the substrate, the equivalent thermal conductivity between the electronic component body model and the substrate model is calculated.

A further known example of this kind of thermal analysis method, thermal analysis apparatus, and computer program is the finite element analysis method, finite element analysis apparatus, and computer program disclosed in Japanese Unexamined Patent Application Publication No. 2007-65803. In this finite element analysis method, the analysis error is calculated on the individual divided elements, and it is determined whether the calculated analysis error of any finite element exceeds a predetermined value. When it is determined that the analysis error of a finite element exceeds the predetermined value, the finite element is subdivided into multiple finite elements, and the analysis error is distributed among the subdivided finite elements. Subsequently, it is determined whether the analysis error distributed to any of the subdivided finite elements exceeds the predetermined value. When it is determined that the analysis error of a finite element exceeds the predetermined value, the finite element is further subdivided, and the analysis error distributed to the finite element before subdivision is redistributed. When it is determined that the analysis error of any finite element does not exceed the predetermined value, finite element analysis is conducted on the subdivided finite elements.

### SUMMARY

However, the known automatic mesh generating apparatus, automatic mesh generating method, and program disclosed in Japanese Unexamined Patent Application Publication No. 2005-50137 reduce calculation costs while maintaining calculation accuracy by firstly dividing wiring patterns into adequately fine meshes and secondly combining meshes that do not need to be partitioned. For this reason, it is necessary to precisely model wiring patterns. This limits reduction of calculation costs.

The thermal analysis method, thermal analysis apparatus, and thermal analysis program disclosed in Japanese Unexamined Patent Application Publication No. 2008-275579 aim to enhance calculation accuracy by weighting complex wiring patterns based on ground connection information to calculate equivalent physical properties. However, no consideration is given to the issue of degradation of calculation accuracy due to discretization in mesh division.

The finite element analysis method, finite element analysis apparatus, and computer program disclosed in Japanese Unexamined Patent Application Publication No. 2007-65803 enhances calculation accuracy in finite element analysis while reducing computational processing loads by further partitioning the elements having larger analysis errors. Although the enhancement of calculation accuracy depends on how analysis errors are determined as indices, no particular mention is made regarding how to effectively determine analysis error indices in thermal analysis.

Accordingly, the present disclosure provides a thermal analysis method for performing thermal analysis on a structure or space. The thermal analysis method includes an initial division step of partitioning an entire region of a structure or space targeted for thermal analysis into calculation meshes and dividing a designated region of the structure or space into a plurality of partitioned regions, an initial thermal analysis step of performing thermal analysis on the structure or space using the calculation meshes generated in the initial division step, and a thermal management sensitivity index calculation step of calculating thermal management sensitivity indices on the individual partitioned regions by calculating volume integrals on the individual partitioned regions, based on inner products of heat flux vectors and temperature gradient vectors calculated on the entire region of the structure or space through the thermal analysis performed in the initial thermal analysis step, and acquiring absolute values of the volume integrals. The method also includes a secondary division step of further partitioning the calculation meshes of a predetermined number of particular partitioned regions among the partitioned regions, the predetermined number of particular partitioned regions indicating greater indices among the thermal management sensitivity indices calculated on the individual partitioned regions in the thermal management sensitivity index calculation step, and subdividing each of the predetermined number of particular partitioned regions into a plurality of partitioned regions, and a secondary thermal analysis step of performing thermal analysis again on the structure or space using the calculation meshes further partitioned in the secondary division step.

The present disclosure provides a thermal analysis apparatus for performing thermal analysis on a structure or space. The thermal analysis apparatus includes initial dividing means for partitioning an entire region of a structure or space targeted for thermal analysis into calculation meshes and dividing a designated region of the structure or space into a plurality of partitioned regions, initial thermal analysis means for performing thermal analysis on the structure or space using the calculation meshes generated by the initial dividing means, and thermal management sensitivity index calculating means for calculating thermal management sensitivity indices on the individual partitioned regions by calculating volume integrals on the individual partitioned regions, based on inner products of heat flux vectors and temperature gradient vectors calculated on the entire region of the structure or space through the thermal analysis performed by the initial thermal analysis means, and acquiring absolute values of the volume integrals. The thermal analysis apparatus also includes secondary dividing means for further partitioning the calculation meshes of a predetermined number of particular partitioned regions among the partitioned regions, the predetermined number of particular partitioned regions indicating greater indices among the thermal management sensitivity indices calculated on the individual partitioned regions by the thermal management sensitivity index calculating means, and subdividing each of the predetermined number of particular partitioned regions into a plurality of partitioned regions, and secondary thermal analysis means for performing thermal analysis again on the structure or space using the calculation meshes further partitioned by the secondary dividing means.

The present disclosure provides a computer program configured to cause a computer to operate as initial dividing means for partitioning an entire region of a structure or space targeted for thermal analysis into calculation meshes and dividing a designated region of the structure or space into a plurality of partitioned regions, initial thermal analysis means for performing thermal analysis on the structure or space using the calculation meshes generated by the initial dividing means, and thermal management sensitivity index calculating means for calculating thermal management sensitivity indices on the individual partitioned regions by calculating volume integrals on the individual partitioned regions, based on inner products of heat flux vectors and temperature gradient vectors calculated on the entire region of the structure or space through the thermal analysis performed by the initial thermal analysis means, and acquiring absolute values of the volume integrals. The computer program is further configured to cause the computer to operate as secondary dividing means for further partitioning the calculation meshes of a predetermined number of particular partitioned regions among the partitioned regions, the predetermined number of particular partitioned regions indicating greater indices among the thermal management sensitivity indices calculated on the individual partitioned regions by the thermal management sensitivity index calculating means, and subdividing each of the predetermined number of particular partitioned regions into a plurality of partitioned regions, and secondary thermal analysis means for performing thermal analysis again on the structure or space using the calculation meshes further partitioned by the secondary dividing means.

With these configurations, thermal analysis is performed using the calculation meshes obtained by partitioning the entire region of a structure or space targeted for thermal analysis, and as a result, the spatial distribution of heat flux vectors and temperature gradient vectors across the entire region of the structure or space is obtained. Based on the obtained spatial distribution, the volume integrals of the inner products of the heat flux vectors and the temperature gradient vectors are calculated on the individual partitioned regions obtained by dividing a designated region of the structure or space, and the absolute values of the volume integrals are acquired. As a result, the thermal management sensitivity indices are calculated on the individual partitioned regions. Subsequently, partition of calculation meshes and subdivision of partitioned regions are performed on a predetermined number of partitioned regions that indicate greater indices among the calculated thermal management sensitivity indices. Thermal analysis is performed again on the structure or space using the further partitioned calculation meshes. As described above, partitioned regions are acquired by dividing a designated region of a structure or space; some partitioned regions having higher importance in thermal management among the partitioned regions are selected based on the thermal management sensitivity index; thermal analysis is accordingly performed on the predetermined number of partitioned regions selected, having higher importance in thermal management. This configuration enables highly accurate thermal analysis on a structure or space, in other words, highly accurate heat transfer simulation of a structure or space, while reducing calculation costs by decreasing computational processing loads for thermal analysis and also avoiding degradation of calculation accuracy due to discretization in region division.

As a result, the present disclosure provides the thermal analysis method, the thermal analysis apparatus, and the computer program that enable highly accurate heat transfer simulation of a structure or space, while reducing calculation costs by decreasing computational processing loads for thermal analysis and also avoiding degradation of calculation accuracy due to discretization in region division.

### BRIEF DESCRIPTION OF THE DRAWINGS

FIG. 1 is a block diagram illustrating a configuration of a thermal analysis apparatus according to a first embodiment of the present disclosure;

FIG. 2 is a flowchart outlining a thermal analysis method according to the first embodiment, implemented by the thermal analysis apparatus illustrated in FIG. 1;

FIGS. 3A and 3B illustrate partitioned regions obtained for thermal analysis according to the first embodiment;

FIG. 4 is a block diagram illustrating a configuration of a thermal analysis apparatus according to a second embodiment of the present disclosure;

FIG. 5 is a flowchart outlining a thermal analysis method according to the second embodiment, implemented by the thermal analysis apparatus illustrated in FIG. 4;

FIGS. 6A-6C illustrate partitioned regions obtained for thermal analysis according to the second embodiment;

FIG. 7 is a block diagram illustrating a configuration of a thermal analysis apparatus according to a third embodiment of the present disclosure;

FIG. 8 is a flowchart outlining a thermal analysis method according to the third embodiment, implemented by the thermal analysis apparatus illustrated in FIG. 7;

FIGS. 9A and 9B illustrate partitioned regions obtained for thermal analysis according to the third embodiment;

FIG. 10 is a graph comparing the thermal analysis results obtained by selectively partitioning a circuit board in the third embodiment with the thermal analysis results obtained by evenly dividing the same circuit board;

FIG. 11 is a block diagram illustrating a configuration of a thermal analysis apparatus according to a fourth embodiment of the present disclosure; and

FIG. 12 is a flowchart outlining a thermal analysis method according to the fourth embodiment, implemented by the thermal analysis apparatus illustrated in FIG. 11.

### DETAILED DESCRIPTION

The following describes embodiments for implementing a thermal analysis method, a thermal analysis apparatus, and a computer program according to the present disclosure.

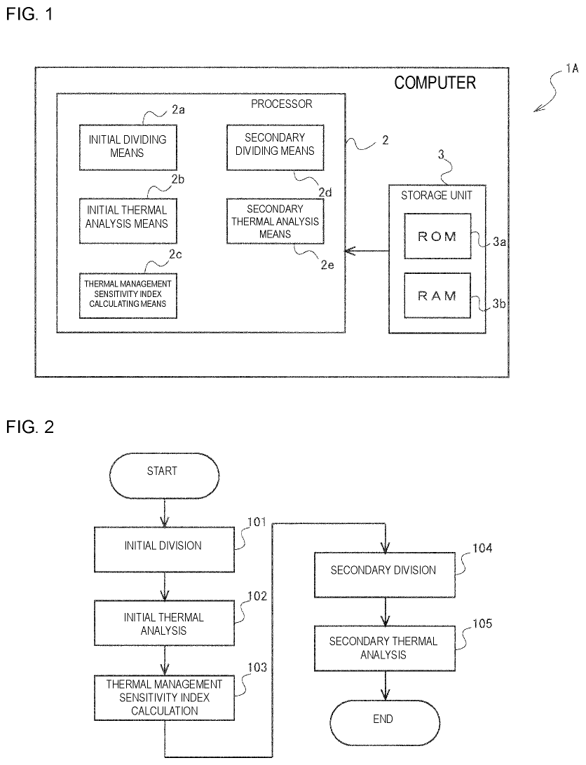

FIG. 1 is a block diagram illustrating a configuration of a thermal analysis apparatus 1A according to a first embodiment of the present disclosure. FIG. 2 is a flowchart outlining a thermal analysis method implemented by the thermal analysis apparatus 1A.

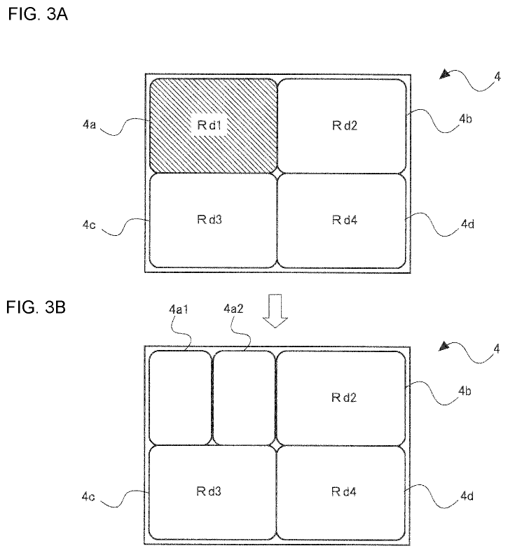

In the descriptions of the present embodiment and subsequent embodiments described later, a circuit board 4 as illustrated in FIGS. 3A and 3B, which has a mounted heat source component such as an integrated circuit (IC) (not illustrated), is used as an example of a structure targeted for thermal analysis for ease of description. However, the circuit board 4 is merely an example of a structure targeted for thermal analysis. A space may also be a thermal analysis target, and thermal analysis may be conducted on the space.

The thermal analysis apparatus 1A is implemented by a computer that includes a processor 2 constituted by, for example, a micro processing unit (MPU) and a storage unit 3 constituted by, for example, a read-only memory (ROM) 3a and a random-access memory (RAM) 3b. The ROM 3a is operable to store computer programs that specify operating procedures of the processor 2 and various kinds of data including thermal information of a structure 4. The processor 2 is operable to control different parts in accordance with the computer program stored in the ROM 3a, while using the RAM 3b as a temporary storage work area.

The processor 2 has initial dividing means 2a, initial thermal analysis means 2b, thermal management sensitivity index calculating means 2c, secondary dividing means 2d, and secondary thermal analysis means 2e, which are functional blocks.

The flowchart illustrated in FIG. 2 is implemented through computational processing by the computer.

In an initial division step 101, the initial dividing means 2a partitions the entire region of the circuit board 4, which is a thermal analysis target, into calculation meshes and performs initial division of dividing a designated region of the circuit board 4, specifically the entire region of the circuit board 4 in this step, into multiple partitioned regions. In the initial division step 101, for example, as illustrated in FIG. 3A, initial division is performed to divide the entire region of the circuit board 4 into four partitioned regions 4a, 4b, 4c, and 4d.

In an initial thermal analysis step 102, the initial thermal analysis means 2b performs thermal analysis on the circuit board 4 using the calculation meshes generated by the initial dividing means 2a. As a result of performing this thermal analysis, the spatial distribution of heat flux vectors J and temperature gradient vectors ∇T across the entire region of the circuit board 4 is acquired as physical quantities.

In a thermal management sensitivity index calculation step 103, the thermal management sensitivity index calculating means 2c calculates thermal management sensitivity indices Rd1, Rd2, Rd3, and Rd4 of the individual partitioned regions 4a, 4b, 4c, and 4d in the following manner: the thermal management sensitivity index calculating means 2c calculates the inner products J·∇T of the physical quantities based on the spatial distribution of the heat flux vectors J and the temperature gradient vectors ∇T acquired in the initial thermal analysis step 102; the thermal management sensitivity index calculating means 2c subsequently calculates the volume integrals over the partitioned regions 4a, 4b, 4c, and 4d and acquires the absolute values of the volume integrals. The thermal management sensitivity indices Rd1, Rd2, Rd3, and Rd4 indicate how much the individual partitioned regions 4a, 4b, 4c, and 4d contribute over the entire heat dissipation management region in thermal management for decreasing the heat source temperature. A greater value of the index means a higher level of effectiveness of thermal management on the corresponding partitioned region.

In a secondary division step 104, the secondary dividing means 2d subdivides a predetermined number of partitioned regions that indicate greater indices among the thermal management sensitivity indices Rd1, Rd2, Rd3, and Rd4 calculated for the partitioned regions 4a, 4b, 4c, and 4d in the thermal management sensitivity index calculation step 103 and also partitions the calculation meshes in the predetermined number of partitioned regions. For example, when the thermal management sensitivity index Rd1 of the partitioned region 4a is the greatest value, the calculation mesh of the partitioned region 4a is further partitioned, and as illustrated in FIG. 3B, the partitioned region 4a is further divided into two partitioned regions 4a1 and 4a2. In this example, the partitioned region 4a that indicates the greatest index among the calculated thermal management sensitivity indices Rd1, Rd2, Rd3, and Rd4 is subdivided into multiple partitioned regions. However, one partitioned region, for example the partitioned region 4a, is not to be interpreted as limiting. For example, the partitioned region 4b that indicates the second greatest index may be added, and partition of calculation meshes and subdivision of partitioned regions may be performed on the two partitioned regions 4a and 4b. One partitioned region is not necessarily divided into two partitioned regions, for example the two partitioned regions 4a1 and 4a2; one partitioned region may be subdivided into three, four, or any number.

In a secondary thermal analysis step 105, the secondary thermal analysis means 2e performs thermal analysis again on the entire region of the circuit board 4 using the calculation meshes partitioned in the secondary division step 104.

In the present embodiment, the computer program stored in the ROM 3a causes the computer constituted by the processor 2 and the storage unit 3 to operate as the initial dividing means 2a, the initial thermal analysis means 2b, the thermal management sensitivity index calculating means 2c, the secondary dividing means 2d, and the secondary thermal analysis means 2e. The initial dividing means 2a is operable to partition the entire region of a structure or space targeted for thermal analysis into calculation meshes and divide a designated region of the structure or space into the multiple partitioned regions 4a, 4b, 4c, and 4d. The initial thermal analysis means 2b is operable to perform thermal analysis on the structure or space using the calculation meshes generated by the initial dividing means 2a. The thermal management sensitivity index calculating means 2c is operable to calculate the thermal management sensitivity indices Rd1, Rd2, Rd3, and Rd4 by calculating the volume integrals for the individual partitioned regions 4a, 4b, 4c, and 4d, based on the spatial distribution of the inner products J·∇T of the heat flux vectors J and the temperature gradient vectors ∇T calculated on the entire region of the structure or space through thermal analysis performed by the initial thermal analysis means 2b, and acquiring the absolute values of the volume integrals. The secondary dividing means 2d is operable to partition the calculation meshes of a predetermined number of partitioned regions 4a that indicate greater indices among the thermal management sensitivity indices Rd1, Rd2, Rd3, and Rd4 calculated for the partitioned regions 4a, 4b, 4c, and 4d by the thermal management sensitivity index calculating means 2c and also subdividing the partitioned region 4a into the partitioned regions 4a1 and 4a2. The secondary thermal analysis means 2e is operable to perform thermal analysis again on the structure or space using the calculation meshes partitioned by the secondary dividing means 2d.

With the thermal analysis method, the thermal analysis apparatus 1A, and the computer program according to the present embodiment, as described above, by performing thermal analysis on a structure or space using the calculation meshes generated by the initial dividing means 2a in the initial division step 101, the spatial distribution of the heat flux vectors J and the temperature gradient vectors ∇T are calculated; by calculating the volume integrals of the inner products J·∇T of the heat flux vectors J and the temperature gradient vectors ∇T for the individual partitioned regions 4a, 4b, 4c, and 4d and acquiring the absolute values of the volume integrals, the thermal management sensitivity indices Rd1, Rd2, Rd3, and Rd4 are calculated for the partitioned regions 4a, 4b, 4c, and 4d. Subsequently, partition of calculation meshes and subdivision of partitioned regions are performed on a predetermined number of partitioned regions that indicate greater indices among the calculated thermal management sensitivity indices Rd1, Rd2, Rd3, and Rd4, for example one partitioned region 4a. Thermal analysis is performed again using the further partitioned calculation meshes. As described above, partitioned regions are acquired by dividing a designated region of a structure or space; some partitioned regions having higher importance in thermal management among the partitioned regions are selected based on a thermal management sensitivity index Rd; the calculation meshes of the predetermined number of partitioned regions having higher importance in thermal management are partitioned; thermal analysis is accordingly performed on the predetermined number of partitioned regions selected.

The thermal management sensitivity index Rd can be used to determine which part of region in the entire region of interest has higher importance in thermal management and which part of region has lower importance. When a region indicates a higher thermal management sensitivity index Rd, the region has a greater influence on the result of thermal analysis calculation. The region having a greater influence on the result is the region on which the spatial resolution needs to be increased for the purpose of improving the calculation accuracy of thermal analysis. Overall, the thermal analysis method, the thermal analysis apparatus 1A, and the computer program according to the present embodiment enable highly accurate heat transfer simulation of a structure or space, while reducing calculation costs by decreasing computational processing loads for thermal analysis and also avoiding degradation of calculation accuracy due to discretization in region division.

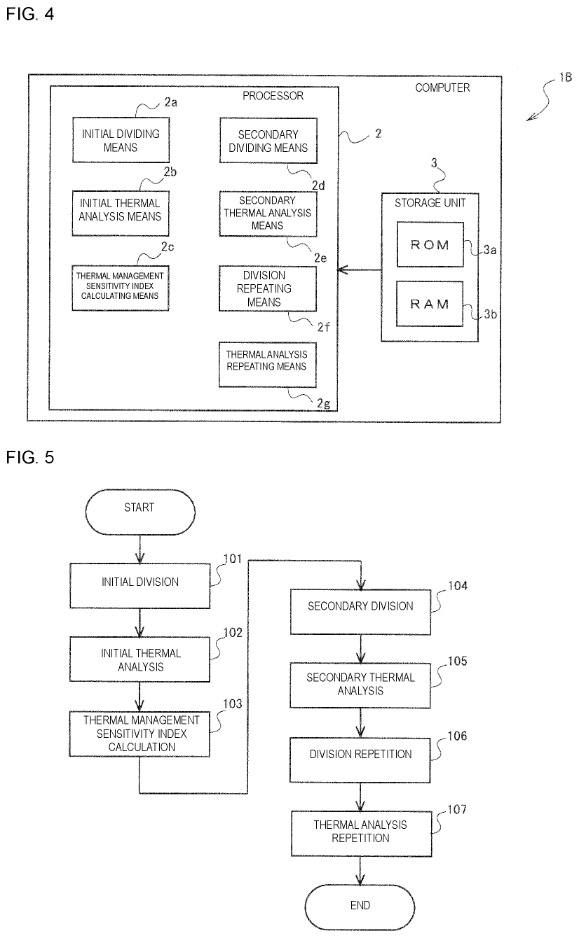

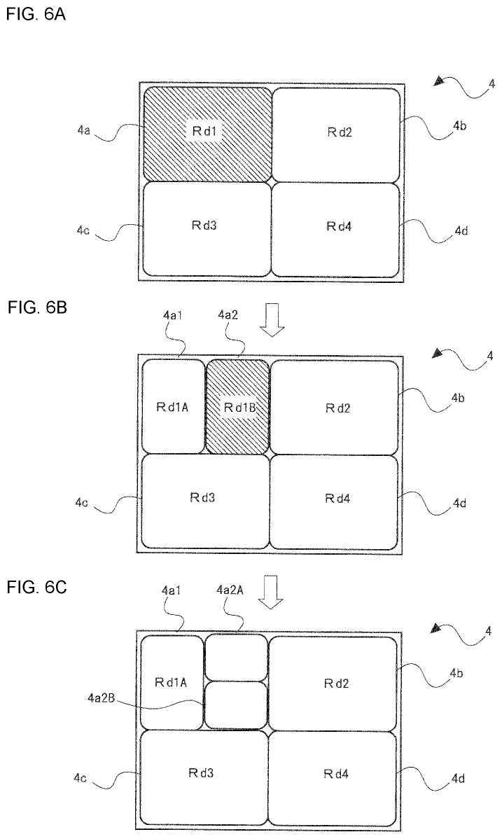

FIG. 4 is a block diagram illustrating a configuration of a thermal analysis apparatus 1B according to a second embodiment of the present disclosure. FIG. 5 is a flowchart outlining a thermal analysis method implemented by the thermal analysis apparatus 1B. FIGS. 6A-6C illustrate a circuit board 4, which is an exemplary structure targeted for thermal analysis in the second embodiment. In FIGS. 4, 5, and 6A-6C, the identical or corresponding parts to the parts in FIGS. 1, 2, 3A and 3B are assigned the same reference numerals, and descriptions thereof are not repeated.

The thermal analysis apparatus 1B according to the second embodiment illustrated in FIG. 4 differs from the thermal analysis apparatus 1A according to the first embodiment illustrated in FIG. 1 in that the processor 2 has division repeating means 2f and thermal analysis repeating means 2g, which are functional blocks. The thermal analysis method according to the second embodiment, illustrated by the flowchart in FIG. 5, differs from the thermal analysis method according to the first embodiment, illustrated by the flowchart in FIG. 2, in that a division repetition step 106 and a thermal analysis repetition step 107 are provided after the secondary thermal analysis step 105.

A computer program according to the second embodiment, stored in the ROM 3a, differs from the computer program according to the first embodiment in the following feature: as well as causing the computer to operate as the means that the computer program according to the first embodiment causes the computer to operate as, the computer program according to the second embodiment causes the computer to additionally operate as the division repeating means 2f and the thermal analysis repeating means 2g. The division repeating means 2f is operable to further partition the calculation meshes of a predetermined number of partitioned regions that indicate greater indices among the thermal management sensitivity indices Rd calculated on the individual partitioned regions through thermal analysis performed by the secondary thermal analysis means 2e and subdivide the predetermined number of partitioned regions into multiple partitioned regions. The thermal analysis repeating means 2g is operable to perform thermal analysis again on a structure or space using the calculation meshes further partitioned by the division repeating means 2f.

In the division repetition step 106 illustrated in FIG. 5 after the secondary thermal analysis step 105, the division repeating means 2f of the thermal analysis apparatus 1B illustrated in FIG. 4 further partitions the calculation meshes of a predetermined number of partitioned regions that indicate greater indices among the thermal management sensitivity indices Rd1A, Rd1B, Rd2, Rd3, and Rd4 calculated on the partitioned regions 4a1, 4a2, 4b, 4c, and 4d through thermal analysis performed in the secondary thermal analysis step 105 and subdivides the predetermined number of partitioned regions into multiple partitioned regions. For example, when the thermal management sensitivity index Rd1B calculated on the partitioned region 4a2 is the greatest value among the thermal management sensitivity indices Rd1A, Rd1B, Rd2, Rd3, and Rd4 as illustrated with diagonals in FIG. 6B, the calculation mesh of the partitioned region 4a2 is further partitioned, and the partitioned region 4a2 is further divided into partitioned regions 4a2A and 4a2B as illustrated in FIG. 6C.

Also in this example, one partitioned region, specifically the partitioned region 4a2, indicating the greatest index among the calculated thermal management sensitivity indices Rd is selected as a target. However, one partitioned region is not to be interpreted as limiting, and partition of calculation meshes and subdivision may be performed on two, three, or any number of partitioned regions. One partitioned region is not necessarily divided into two, for example 4a2A and 4a2B; one partitioned region may be subdivided into three, four, or any number.

In the thermal analysis repetition step 107, the thermal analysis repeating means 2g performs thermal analysis again on the circuit board 4 using the calculation meshes partitioned in the division repetition step 106.

The thermal analysis method, the thermal analysis apparatus 1B, and the computer program according to the second embodiment enhance analysis accuracy by repetitively performing partition of calculation meshes and thermal analysis on a predetermined number of partitioned regions that indicate greater indices among the thermal management sensitivity indices Rd, as described above.

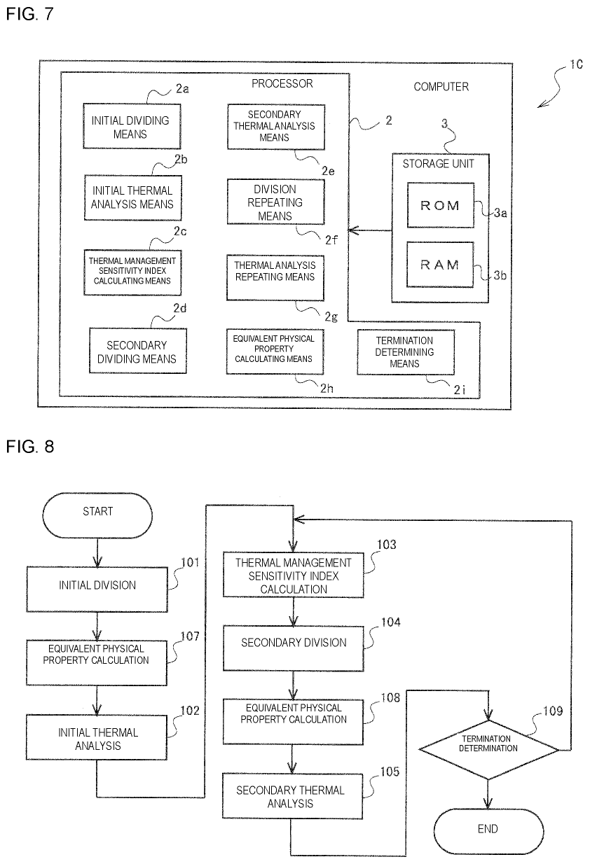

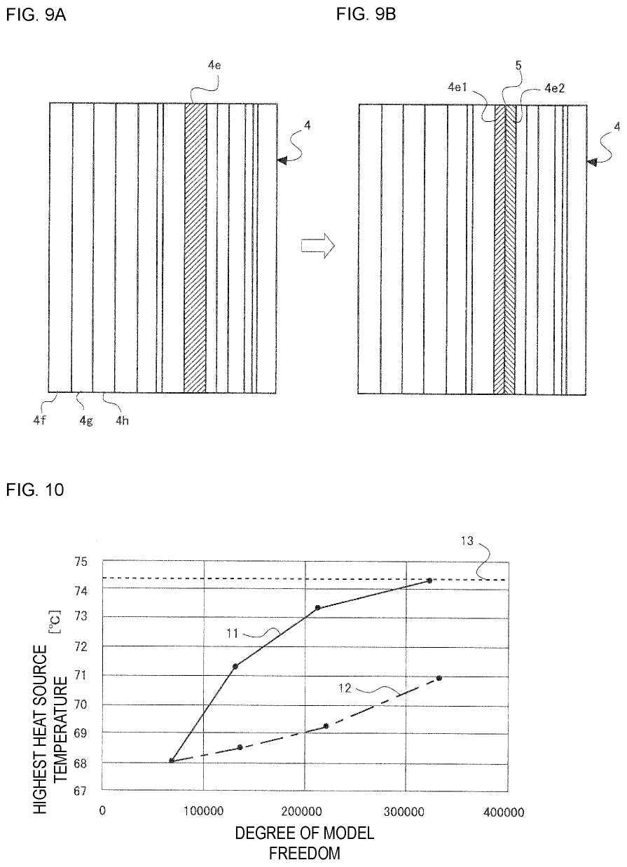

FIG. 7 is a block diagram illustrating a configuration of a thermal analysis apparatus 1C according to a third embodiment of the present disclosure. FIG. 8 is a flowchart outlining a thermal analysis method implemented by the thermal analysis apparatus 1C. FIGS. 9A and 9B illustrate a circuit board 4, which is an exemplary structure targeted for thermal analysis in the third embodiment. In FIGS. 7, 8, 9A and 9B, the identical or corresponding parts to the parts in FIGS. 4, 5, and 6A-6C are assigned the same reference numerals, and descriptions thereof are not repeated.

The thermal analysis apparatus 1C according to the third embodiment illustrated in FIG. 7 differs from the thermal analysis apparatus 1B according to the second embodiment illustrated in FIG. 4 in that the processor 2 has equivalent physical property calculating means 2h and termination determining means 2i, which are functional blocks.

The thermal analysis method according to the third embodiment illustrated by the flowchart in FIG. 8 differs from the thermal analysis method according to the second embodiment illustrated by the flowchart in FIG. 5 in the following features: equivalent physical property calculation steps 108 are provided; loop processing as described later is provided; loop processing of the secondary division step 104 and the secondary thermal analysis step 105 serve as the division repetition step 106 and the thermal analysis repetition step 107; and loop processing is repeated until termination is determined in a termination determination step 109. The thermal management sensitivity index calculation step 103, the secondary division step 104, the equivalent physical property calculation step 108, and the secondary thermal analysis step 105 constitute loop processing.

The third embodiment differs from the second embodiment in that in the initial division step 101 implemented by the initial dividing means 2a and the secondary division step 104 implemented by the secondary dividing means 2d, the partitioned regions are acquired by dividing a designated region of a structure or space targeted for thermal analysis in one direction.

The computer program according to the third embodiment, stored in the ROM 3a, differs from the computer program according to the second embodiment in the following features: as well as causing the computer to operate as the means that the computer program according to the second embodiment causes the computer to operate as, the computer program according to the third embodiment causes the computer to operate as the equivalent physical property calculating means 2h for calculating equivalent physical properties on equivalent physical property calculation regions that are set in the partitioned regions, based on physical property values of materials forming the equivalent physical property calculation regions; the secondary dividing means 2d and the division repeating means 2f are caused to perform partition of the calculation meshes and subdivision of the partitioned regions and perform partition of the equivalent physical property calculation regions of the subdivided partitioned regions; thermal analysis is performed using the equivalent physical properties calculated on the equivalent physical property calculation regions partitioned by the equivalent physical property calculating means 2h; and the partitioned regions are acquired by dividing a designated region of a structure or space targeted for thermal analysis in one direction.

In the initial division step 101 illustrated in FIG. 8, the initial dividing means 2a of the thermal analysis apparatus 1C illustrated in FIG. 7 partitions the entire region of a structure or space into calculation meshes, divides a designated region of the structure or space into multiple partitioned regions, and set equivalent physical property calculation regions for calculating equivalent physical properties in the individual partitioned regions by performing region division for equivalent physical property calculation in the same manner as calculation mesh division. In the present embodiment, division into multiple partitioned regions is performed such that the entire region of the circuit board 4 having a given thickness is divided in one direction into strips as illustrated in FIG. 9A. Accordingly, the partitioned regions are acquired as rectangular parallelepipeds. Initial division into partitioned regions in the initial division step 101 is performed in a sparse manner, because the regions generated by initial division will be further partitioned in later steps. In the equivalent physical property calculation steps 108, the equivalent physical property calculating means 2h calculates the equivalent physical properties on the individual equivalent physical property calculation regions, based on the physical property values of the materials in the equivalent physical property calculation regions. Thermal analysis by the initial thermal analysis means 2b in the initial thermal analysis step 102 and thermal analysis by the secondary thermal analysis means 2e in the secondary thermal analysis step 105 are performed using the equivalent thermal conductivities calculated on the individual partitioned equivalent physical property calculation regions in the equivalent physical property calculation steps 108.

In the secondary division step 104, the secondary dividing means 2d evenly subdivides a partitioned region that indicates the greatest index among the thermal management sensitivity indices Rd calculated on the strip-shaped partitioned regions in the thermal management sensitivity index calculation step 103, for example a partitioned region 4e indicated by diagonals in FIG. 9A, into two partitioned regions 4e1 and 4e2 by a dividing line 5 as illustrated in FIG. 9B; the secondary dividing means 2d also partitions the calculation mesh and the equivalent physical property calculation region in the partitioned region 4e. The above describes the example in which the partitioned region 4e that indicates the greatest index is subdivided. However, the same processing may be performed on the partitioned regions of a predetermined number of greatest indices. In the equivalent physical property calculation step 108, the equivalent physical property calculating means 2h calculates the equivalent physical properties on the partitioned equivalent physical property calculation regions. In the secondary thermal analysis step 105, the secondary thermal analysis means 2e performs thermal analysis again using the calculated equivalent physical properties.

In the termination determination step 109, the termination determining means 2i determines whether a thermal analysis calculation result calculated through thermal analysis in the secondary thermal analysis step 105 has reached a predetermined level of accuracy. When the thermal analysis calculation result has not reached the predetermined level of accuracy, loop processing of the thermal management sensitivity index calculation step 103, the secondary division step 104, the equivalent physical property calculation step 108, and the secondary thermal analysis step 105 is repeated. When it is determined in the termination determination step 109 that the thermal analysis calculation result in the secondary thermal analysis step 105 has reached the predetermined level of accuracy, thermal analysis terminates.

In termination determination in the termination determination step 109, it is determined that the thermal analysis calculation result has reached a predetermined level of accuracy, for example, when variations in temperature of a heat source component mounted on the circuit board 4, which are measured through simulation by thermal analysis calculation in the secondary thermal analysis step 105, are sufficiently small.

The thermal analysis method, the thermal analysis apparatus 1C, and the computer program according to the third embodiment perform thermal analysis while selectively partitioning the equivalent physical property calculation region of a particular partitioned region that has a greater influence on the analysis result and calculating the physical properties on the individual partitioned equivalent physical property calculation regions. As a result, the thermal analysis method, the thermal analysis apparatus 1C, and the computer program according to the third embodiment enable thermal analysis with increased accuracy on thermal analysis targets having complex shapes, such as wiring patterns, by selectively performing thermal analysis on a predetermined number of partitioned regions that have greater importance in thermal management. A typical example of the equivalent physical property is equivalent thermal conductivity. Equivalent thermal conductivity represents the average heat transfer characteristic of a region that includes multiple kinds of materials, by using, for example, the thermal conductivities and content ratios of the constituent materials. The use of equivalent thermal conductivity greatly simplifies models when the models involve patterns having complex shapes. However, this can lead to degradation in thermal analysis accuracy. The degradation of accuracy caused as described above depends on the size of the region considered for equivalent thermal conductivity interpretation. When a region having a large size is considered for equivalent thermal conductivity interpretation, the accuracy degrades to a greater extent. By contrast, many regions having a small size are considered for equivalent thermal conductivity interpretation, the degradation of accuracy is minimized. As described in the third embodiment, when the calculation mesh of a selected partitioned region that has a greater influence on calculation accuracy is partitioned, the equivalent physical property calculation region for calculating the equivalent thermal conductivity of the region is also partitioned. This configuration minimizes the effect of accuracy degradation due to the use of equivalent thermal conductivity. As a result, the third embodiment enables heat transfer simulation of a structure or space with high accuracy when the thermal analysis target has a complex shape, by enhancing accuracy of both of the partition of regions and the calculation of equivalent thermal conductivity while reducing computational processing loads.

The partitioned regions are acquired by dividing a designated region of the structure or space targeted for thermal analysis in one direction. This eliminates the need to consider connections between adjacent regions in this direction. This configuration further reduces processing loads during calculation mesh partition, resulting in a further reduction in calculation costs.

In the third embodiment, the case in which partitioned regions are acquired by dividing a designated region of a structure or space in one direction has been described. However, a designated region of a structure or space can be more efficiently partitioned for thermal analysis by additionally providing partitioned regions in the directions perpendicular to the one direction and partitioning the regions that have greater importance two-dimensionally in two directions or three-dimensionally in three directions. The method of dividing a designated region in one direction may be applied to thermal analysis according to the first and second embodiments. In such a case, the same effects and advantages can be achieved.

FIG. 10 is a graph comparing the thermal analysis results obtained by selectively partitioning the circuit board 4 in the third embodiment with the thermal analysis results obtained by evenly dividing the same circuit board 4. The horizontal axis in the graph represents the degree of model freedom, which indicates the level of sparseness in region division. A lower degree of model freedom means a higher level of sparseness; a higher degree of model freedom means a lower level of sparseness. The vertical axis in the graph represents the highest temperature [° C.] of a heat source component. A characteristic line 11, illustrated as a zigzag solid line, represents the thermal analysis results according to the third embodiment. A characteristic line 12, illustrated as a zigzag dot-dash line, represents the thermal analysis results obtained by evenly dividing the region. A characteristic line 13, illustrated as a straight dotted line, represents the results of thermal analysis using a shape model created as a precise reproduction. It can be understood from the graph that the characteristic line 11 indicates the thermal analysis results close to the characteristic line 13 than the characteristic line 12 at the same degrees of model freedom; and highly accurate analysis results closer to the thermal analysis results based on the precise shape model are obtained through thermal analysis with selective partition of the circuit board 4 according to the third embodiment, in comparison to thermal analysis with even region division.

In the embodiments described above, the case in which partitioned regions are further decreased in size by firstly partitioning a designated region, and as well as partitioning the calculation meshes and equivalent physical property calculation regions in particular partitioned regions that indicate greater thermal management sensitivity indices Rd, secondly subdividing the partitioned regions has been described. However, conversely, by enlarging the calculation meshes and equivalent physical property calculation regions of particular partitioned regions that indicate smaller thermal management sensitivity indices Rd and combining the partitioned regions, a designated region of a structure or space can be efficiently divided for thermal analysis.

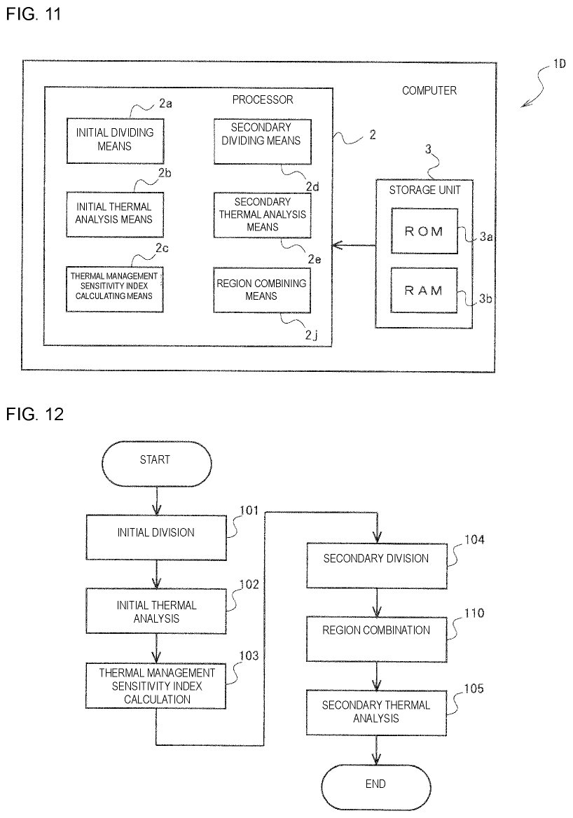

FIG. 11 is a block diagram illustrating a configuration of a thermal analysis apparatus 1D for performing this kind of thermal analysis, according to a fourth embodiment of the present disclosure. FIG. 12 is a flowchart outlining a thermal analysis method implemented by the thermal analysis apparatus 1D. In FIGS. 11 and 12, the identical or corresponding parts to the parts in FIGS. 1 and 2 are assigned the same reference numerals, and descriptions thereof are not repeated.

The thermal analysis apparatus 1D according to the fourth embodiment illustrated in FIG. 11 differs from the thermal analysis apparatus 1A according to the first embodiment illustrated in FIG. 1 in that the processor 2 has region combining means 2j, which is a functional block; the region combining means 2j is operable to combine into a single combined region a predetermined number of adjacent partitioned regions that indicate smaller indices among the thermal management sensitivity indices Rd calculated on the partitioned regions by the thermal management sensitivity index calculating means 2c. The thermal analysis method according to the fourth embodiment, illustrated by the flowchart in FIG. 12, differs from the thermal analysis method according to the first embodiment, illustrated by the flowchart in FIG. 2, in that a region combination step 110 is provided after the secondary division step 104.

The computer program according to the fourth embodiment, stored in the ROM 3a, differs from the computer program according to the first embodiment in that as well as causing the computer to operate as the means that the computer program according to the first embodiment causes the computer to operate as, the computer program according to the fourth embodiment causes the computer to additionally operate as the region combining means 2j for combining into a single combined region a predetermined number of adjacent partitioned regions that indicate smaller indices among the thermal management sensitivity indices Rd calculated on the partitioned regions by the thermal management sensitivity index calculating means 2c.

In the secondary division step 104, the secondary dividing means 2d subdivides a predetermined number of partitioned regions that indicate greater indices among the thermal management sensitivity indices Rd calculated for the partitioned regions in the thermal management sensitivity index calculation step 103. For example, the partitioned region 4e, which indicates the greatest thermal management sensitivity index Rd among the partitioned regions of the circuit board 4 partitioned as illustrated in FIG. 9A, is subdivided into the two partitioned regions 4e1 and 4e2 as illustrated in FIG. 9B.

In the region combination step 110, the region combining means 2j combines into a single combined region a predetermined number of adjacent partitioned regions that indicate smaller indices among the thermal management sensitivity indices Rd calculated on the partitioned regions in the thermal management sensitivity index calculation step 103 and also sparsely reshape the calculation meshes and equivalent physical property calculation regions in these partitioned regions. For example, when three adjacent partitioned regions 4f, 4g, and 4h illustrated in FIG. 9A indicate smaller indices among the calculated thermal management sensitivity indices Rd, these three partitioned regions 4f, 4g, and 4h are combined into a single combined region, and additionally, the calculation meshes and equivalent physical property calculation regions in the partitioned regions 4f, 4g, and 4h are sparsely reshaped. The combined region is stored in the storage unit 3. The secondary thermal analysis means 2e performs thermal analysis again using the calculation meshes and equivalent physical property calculation regions subjected to partition and sparse reshaping in the secondary division step 104.

As described above, the thermal analysis method, the thermal analysis apparatus 1D, and the computer program according to the fourth embodiment combine into a single combined region a predetermined number of adjacent partitioned regions that indicate smaller indices among the thermal management sensitivity indices Rd and also sparsely reshape the calculation meshes and equivalent physical property calculation regions in the partitioned regions. As a result, this configuration reduces calculation loads by sparsely reshaping a predetermined number of adjacent partitioned regions that indicate smaller thermal management sensitivity indices Rd among the partitioned regions obtained by dividing a designated region of a structure or space, which means that the predetermined number of partitioned regions have smaller importance in thermal management. Additionally, this configuration enables calculation while efficiently evaluating influences of the individual partitioned regions on thermal analysis and avoiding degradation of calculation accuracy due to discretization in region division.

In the embodiments described above, similarly to the fourth embodiment, a predetermined number of adjacent partitioned regions that indicate smaller thermal management sensitivity indices Rd may be combined into a single combined region to be stored. This configuration achieves the same effects and advantages as in the fourth embodiment.

In the fourth embodiment, the case in which a predetermined number of partitioned regions are divided again into multiple partitioned regions in the secondary division step 104 has been described. However, rather than performing the operation in the secondary division step 104, a predetermined number of partitioned regions may be combined into a single combined region, and the calculation meshes and equivalent physical property calculation regions may be sparsely reshaped in the region combination step 110. With this configuration, the predetermined number of partitioned regions can be treated as a single combined region in the following processing. This configuration thus reduces calculation loads.

What is claimed is:

1. A thermal analysis method for performing thermal analysis on a structure or space, comprising:
an initial division process of partitioning an entire region of a structure or space targeted for thermal analysis into calculation meshes and dividing a designated region of the structure or space into a plurality of partitioned regions;
an initial thermal analysis process of performing thermal analysis on the structure or space using the calculation meshes generated in the initial division process;
a thermal management sensitivity index calculation process of calculating thermal management sensitivity indices on the individual partitioned regions by calculating volume integrals on the individual partitioned regions, based on inner products of heat flux vectors and temperature gradient vectors calculated on the entire region of the structure or space through the thermal analysis performed in the initial thermal analysis process, and acquiring absolute values of the volume integrals;
a secondary division process of further partitioning the calculation meshes of a predetermined number of particular partitioned regions among the partitioned regions, the predetermined number of particular partitioned regions indicating greater indices among the thermal management sensitivity indices calculated on the individual partitioned regions in the thermal management sensitivity index calculation process, and subdividing each of the predetermined number of particular partitioned regions into a plurality of partitioned regions; and
a secondary thermal analysis process of performing thermal analysis again on the structure or space using the calculation meshes further partitioned in the secondary division process.

2. The thermal analysis method according to claim 1, further comprising:
a division repetition process of further partitioning the calculation meshes of a predetermined number of particular partitioned regions among the partitioned regions, the predetermined number of particular partitioned regions indicating greater indices among the thermal management sensitivity indices calculated on the individual partitioned regions through the thermal analysis performed in the secondary thermal analysis process, and subdividing each of the predetermined number of particular partitioned regions into a plurality of partitioned regions; and
a thermal analysis repetition process of performing thermal analysis again on the structure or space using the calculation meshes further partitioned in the division repetition process.

3. The thermal analysis method according to claim 2, further comprising:
an equivalent physical property calculation process of calculating equivalent physical properties on equivalent physical property calculation regions that are set in the partitioned regions, based on physical property values of materials in the equivalent physical property calculation regions, wherein
in the secondary division process and the division repetition process, partitioning of the calculation meshes and subdivision of the partitioned regions are performed, and partitioning of the equivalent physical property calculation regions of the subdivided partitioned regions is also performed, and
the thermal analysis is performed using the equivalent physical properties calculated on the individual equivalent physical property calculation regions partitioned in the equivalent physical property calculation process.

4. The thermal analysis method according to claim 1, further comprising:
a region combination process of combining a predetermined number of adjacent partitioned regions among the partitioned regions into a single combined region, the predetermined number of adjacent partitioned regions indicating smaller indices among the thermal management sensitivity indices calculated on the individual partitioned regions in the thermal management sensitivity index calculation process.

5. The thermal analysis method according to claim 1, wherein
the partitioned regions are obtained by dividing the designated region of the structure or space targeted for thermal analysis in one direction.

6. The thermal analysis method according to claim 2, further comprising:
a region combination process of combining a predetermined number of adjacent partitioned regions among the partitioned regions into a single combined region, the predetermined number of adjacent partitioned regions indicating smaller indices among the thermal management sensitivity indices calculated on the individual partitioned regions in the thermal management sensitivity index calculation process.

7. The thermal analysis method according to claim 3, further comprising:
a region combination process of combining a predetermined number of adjacent partitioned regions among the partitioned regions into a single combined region, the predetermined number of adjacent partitioned regions indicating smaller indices among the thermal management sensitivity indices calculated on the individual partitioned regions in the thermal management sensitivity index calculation process.

8. The thermal analysis method according to claim 2, wherein
the partitioned regions are obtained by dividing the designated region of the structure or space targeted for thermal analysis in one direction.

9. A thermal analysis apparatus for performing thermal analysis on a structure or space, comprising:
a processor configured to perform
an initial dividing process for partitioning an entire region of a structure or space targeted for thermal analysis into calculation meshes and dividing a designated region of the structure or space into a plurality of partitioned regions;
an initial thermal analysis process for performing thermal analysis on the structure or space using the calculation meshes generated by the initial dividing process;
a thermal management sensitivity index calculating process for calculating thermal management sensitivity indices on the individual partitioned regions by calculating volume integrals on the individual partitioned regions, based on inner products of heat flux vectors and temperature gradient vectors calculated on the entire region of the structure or space through the thermal analysis performed by the initial thermal analysis process, and acquiring absolute values of the volume integrals;
a secondary dividing process for further partitioning the calculation meshes of a predetermined number of particular partitioned regions among the partitioned regions, the predetermined number of particular partitioned regions indicating greater indices among the thermal management sensitivity indices calculated on the individual partitioned regions by the thermal management sensitivity index calculating process, and subdividing each of the predetermined number of particular partitioned regions into a plurality of partitioned regions; and
a secondary thermal analysis process for performing thermal analysis again on the structure or space using the calculation meshes further partitioned by the secondary dividing process.

10. The thermal analysis apparatus according to claim 9, wherein
the processor is further configured to perform
a division repeating process for further partitioning the calculation meshes of a predetermined number of particular partitioned regions among the partitioned regions, the predetermined number of particular partitioned regions indicating greater indices among the thermal management sensitivity indices calculated on the individual partitioned regions through the thermal analysis performed by the secondary thermal analysis process, and subdividing each of the predetermined number of particular partitioned regions into a plurality of partitioned regions; and
a thermal analysis repeating process for performing thermal analysis again on the structure or space using the calculation meshes further partitioned by the division repeating process.

11. The thermal analysis apparatus according to claim 10, wherein
the processor is further configured to perform
an equivalent physical property calculating process for calculating equivalent physical properties on equivalent physical property calculation regions that are set in the partitioned regions, based on physical property values of materials in the equivalent physical property calculation regions,
the secondary dividing process and the division repeating process perform partition of the calculation meshes and subdivision of the partitioned regions and also perform partition of the equivalent physical property calculation regions of the subdivided partitioned regions, and
the thermal analysis is performed using the equivalent physical properties calculated on the individual equivalent physical property calculation regions partitioned by the equivalent physical property calculating process.

12. The thermal analysis apparatus according to claim 9, wherein
the processor is further configured to perform
a region combining process for combining a predetermined number of adjacent partitioned regions among the partitioned regions into a single combined region, the predetermined number of adjacent partitioned regions indicating smaller indices among the thermal management sensitivity indices calculated on the individual partitioned regions by the thermal management sensitivity index calculating process.

13. The thermal analysis apparatus according to claim 9, wherein
the partitioned regions are obtained by dividing the designated region of the structure or space targeted for thermal analysis in one direction.

14. The thermal analysis apparatus according to claim 10, wherein
the processor is further configured to perform
a region combining process for combining a predetermined number of adjacent partitioned regions among the partitioned regions into a single combined region, the predetermined number of adjacent partitioned regions indicating smaller indices among the thermal management sensitivity indices calculated on the individual partitioned regions by the thermal management sensitivity index calculating process.

15. The thermal analysis apparatus according to claim 11, wherein
the processor is further configured to perform
a region combining process for combining a predetermined number of adjacent partitioned regions among the partitioned regions into a single combined region, the predetermined number of adjacent partitioned regions indicating smaller indices among the thermal management sensitivity indices calculated on the individual partitioned regions by the thermal management sensitivity index calculating process.

16. Anon-transitory computer-readable medium that stores a program configured to cause a computer to perform:
an initial dividing process for partitioning an entire region of a structure or space targeted for thermal analysis into calculation meshes and dividing a designated region of the structure or space into a plurality of partitioned regions;
an initial thermal analysis process for performing thermal analysis on the structure or space using the calculation meshes generated by the initial dividing process;
a thermal management sensitivity index calculating process for calculating thermal management sensitivity indices on the individual partitioned regions by calculating volume integrals on the individual partitioned regions, based on inner products of heat flux vectors and temperature gradient vectors calculated on the entire region of the structure or space through the thermal analysis performed by the initial thermal analysis process, and acquiring absolute values of the volume integrals;
a secondary dividing process for further partitioning the calculation meshes of a predetermined number of particular partitioned regions among the partitioned regions, the predetermined number of particular partitioned regions indicating greater indices among the thermal management sensitivity indices calculated on the individual partitioned regions by the thermal management sensitivity index calculating process, and subdividing each of the predetermined number of particular partitioned regions into a plurality of partitioned regions; and
a secondary thermal analysis process for performing thermal analysis again on the structure or space using the calculation meshes further partitioned by the secondary dividing process.

17. The non-transitory computer-readable medium according to claim 16,
wherein the program is further configured to cause the computer to perform a division repeating process for further partitioning the calculation meshes of a predetermined number of particular partitioned regions among the partitioned regions, the predetermined number of particular partitioned regions indicating greater indices among the thermal management sensitivity indices calculated on the individual partitioned regions through the thermal analysis performed by the secondary thermal analysis process, and subdividing each of the predetermined number of particular partitioned regions into a plurality of partitioned regions; and
a thermal analysis repeating process for performing thermal analysis again on the structure or space using the calculation meshes further partitioned by the division repeating process.

18. The non-transitory computer-readable medium according to claim 16,
wherein the program is further configured to cause the computer to perform an equivalent physical property calculating process for calculating equivalent physical properties on equivalent physical property calculation regions that are set in the partitioned regions, based on physical property values of materials in the equivalent physical property calculation regions, wherein
the secondary dividing process and the division repeating process are caused to perform partition of the calculation meshes and subdivision of the partitioned regions and also perform partition of the equivalent physical property calculation regions of the subdivided partitioned regions, and
the thermal analysis is performed using the equivalent physical properties calculated on the individual equivalent physical property calculation regions partitioned by the equivalent physical property calculating process.

19. The non-transitory computer-readable medium according to claim 16,
wherein the program is further configured to cause the computer to perform a region combining process for combining a predetermined number of adjacent partitioned regions among the partitioned regions into a single combined region, the predetermined number of adjacent partitioned regions indicating smaller indices among the thermal management sensitivity indices calculated on the individual partitioned regions by the thermal management sensitivity index calculating process.

20. The non-transitory computer-readable medium according to claim 16, wherein
the partitioned regions are obtained by dividing the designated region of the structure or space targeted for thermal analysis in one direction.
